(19) United States
(12) Patent Application Publication
(10) Pub. No.: US 2019/0130036 A1
(43) Pub. Date: May 2, 2019

(54) IDENTIFYING USER INTENTION FROM ENCRYPTED BROWSING ACTIVITY

(71) Applicant: T-Mobile USA, Inc., Bellevue, WA (US)

(72) Inventors: Rami Al-Kabra, Bothell, WA (US); Ruchir Sinha, Newcastle, WA (US); Prem Kumar Bodiga, Bellevue, WA (US); Ijaz Ahamed, Bellevue, WA (US); Jonathan Morrow, Seattle, WA (US)

(21) Appl. No.: 15/795,122

(22) Filed: Oct. 26, 2017

(51) Int. Cl. G06F 17/30

(52) U.S. Cl. CPC G06F 17/30867; G06F 17/30991

(57) ABSTRACT

Techniques for understanding a user's intentions when the user is searching web sites on the Internet are disclosed. Although search queries are typically encrypted so they cannot be understood by entities other than the user and a host of a search engine being used, the present techniques describe ways that a third party can infer user intentions from encrypted activity. Determination of user intentions in ways described herein can be used to provide content to a user that may be of particular interest to the user. Furthermore, provision of such content is thereby not limited to a host of a search engine, as is typically the case when only the host can comprehend content of search queries.

### BACKGROUND

Understanding a user's intentions when the user is searching web sites on the Internet is important for many different reasons. Such data can be used, for example, to provide a better user experience by suggesting web sites, content, or search terms that may assist the user in locating information or a commercial item for which the user is searching. However, search queries are typically encrypted so they cannot be understood by entities other than the user and a host of a search engine being used. Comprehension of a user's intentions by entities other than the search engine host would allow a greater number of parties to provide information that is beneficial to the user.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a diagram of an example cellular network environment in which the technological solutions described herein may be implemented.

FIG. 2 is a diagram of an example computing device in accordance with the technologies described herein.

FIG. 3 is a flow diagram of an example methodological implementation for identifying user intention from encrypted browsing activity.

### DETAILED DESCRIPTION

### Overview

This disclosure is directed to techniques for understanding a user's intentions when the user is searching web sites on the Internet are disclosed. Although search queries are typically encrypted so they cannot be understood by entities other than the user and a host of a search engine being used, the present techniques describe ways that a third party can infer user intentions from encrypted activity. Determination of user intentions in ways described herein can be used to provide content to a user that may be of particular interest to the user. Furthermore, provision of such content is thereby not limited to a host of a search engine, as is typically the case when only the host can comprehend content of search queries.

In the present techniques, an entity that has access to URL (Uniform Resource Locator) content, such as a cellular network operator, monitors network communications between a client and one or more web sites available via the Internet. Although such communications are typically unavailable to parties other than the client and a web site host, the network operator must, by virtue of its role of connecting clients to web sites, have access to network addresses accessed by clients. This information can be used to identify when a user is performing a search, and to infer information about a topic of a user's search.

A reverse IP lookup operation or Server Name Indication (SNI) can be used to identify traffic sent to sites hosted by a search engine provider. Since search queries are usually short, a filtering operation can ignore longer communications as not representing a search. When a communication is identified as a search, the user's subsequent navigations can be monitored to derive a topic of the search. When a search topic is identified, certain actions can be taken with respect to the user and the search topic. For example, content related to the search topic may be communicated with a user, either directly or indirectly.

Details regarding the novel techniques reference above are presented herein are described in detail, below, with respect to several figures that identify elements and operations used in systems, devices, methods, computer-readable storage media, etc. that implement the techniques.

### Example Network Environment

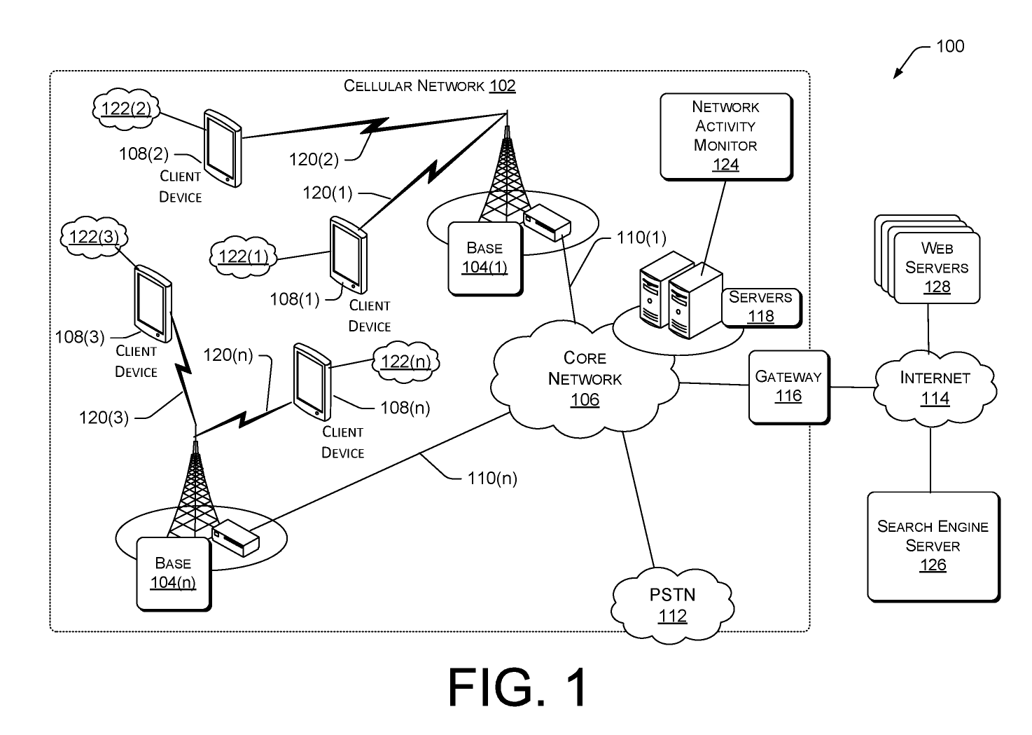

FIG. 1 is a diagram of an example cellular network environment 100 in which the technological solutions described herein may be implemented. FIG. 1 illustrates the concept of identifying a user's intention from encrypted browsing activity. It is noted that, although the present discussion refers to a cellular network, other network architectures may be used in place of the cellular network shown and described with respect to FIG. 1.

The network architecture 100 includes a cellular network 102 that is provided by a wireless telecommunication carrier. The cellular network 102 includes cellular network base stations 104(1)-104(n) and a core network 106. Although only two base stations are shown in this example, the cellular network 102 may comprise any number of base stations. The cellular network 102 provides telecommunication and data communication in accordance with one or more technical standards, such as Enhanced Data Rates for GSM Evolution (EDGE), Wideband Code Division Multiple Access (W-CDMA), HSPA, LTE, LTE-Advanced, CDMA-2000 (Code Division Multiple Access 2000), and/or so forth.

The base stations 104(1)-104(n) are responsible for handling voice and data traffic between client devices, such as client devices 108(1)-108(n), and the core network 106. Each of the base stations 104(1)-104(n) may be communicatively connected to the core network 106 via a corresponding backhaul 110(1)-110(n). Each of the backhauls 110(1)-110(n) are implemented using copper cables, fiber optic cables, microwave radio transceivers, and/or the like.

The core network 106 also provides telecommunication and data communication services to the client devices 108(1)-108(n). In the present example, the core network 106 connects the user devices 108(1)-108(n) to other telecommunication and data communication networks, such as a public switched telephone network (PSTN) 112, and the Internet 114 (via a gateway 116). The core network 106 includes one or more servers 118 that implement network components. For example, the network components (not shown) may include a serving GPRS support node (SGSN) that routes voice calls to and from the PSTN 112, a Gateway GPRS Support Node (GGSN) that handles the routing of data communication between external packet switched networks and the core network 106 via gateway 116. The network components may further include a Packet Data Network (PDN) gateway (PGW) that routes data traffic between the GGSN and the Internet 114.

Each of the client devices 108(1)-108(n) is an electronic communication device, including but not limited to, a smartphone, a tablet computer, an embedded computer system, etc. Any electronic device that is capable of using the wireless communication services that are provided by the cellular network 102 may be communicatively linked to the cellular network 102. For example, a user may use a client device 108 to make voice calls, send and receive text messages, and download content from the Internet 114. A client device 108 is communicatively connected to the core network 106 via base station 104. Accordingly, communication traffic between a client device 108(1)-108(n) and the core network 106 are handled by wireless interfaces 120(1)-120(n) that connect the client devices 108(1)-108(n) to the base stations 104(1)-104(n).

Each of the client devices 108(1)-108(n) are also capable of connecting to an external network, including the Internet, via a wireless network connection other than the cellular network wireless services. As shown, client device 108(1) includes a connection to network 122(1), client device 108(2) includes a connection to network 122(2), client device 108(3) includes a connection to network 122(3), and client device 108(n) includes a connection to network 122(n). The wireless connections are made by way of any method known in the art, such as Bluetooth®, WiFi, Wireless Mesh Network (WMN), etc.

At least one of the servers 118 includes a network activity monitor 124, which can be implemented as a software application stored in memory (not shown). Additionally, apart from the cellular network 102, the cellular network environment 100 includes a search engine server 126 that provide a search engine functionality to users by way of the Internet 114, and multiple web servers 128 that are accessed through the Internet 114.

### Example Computing Device

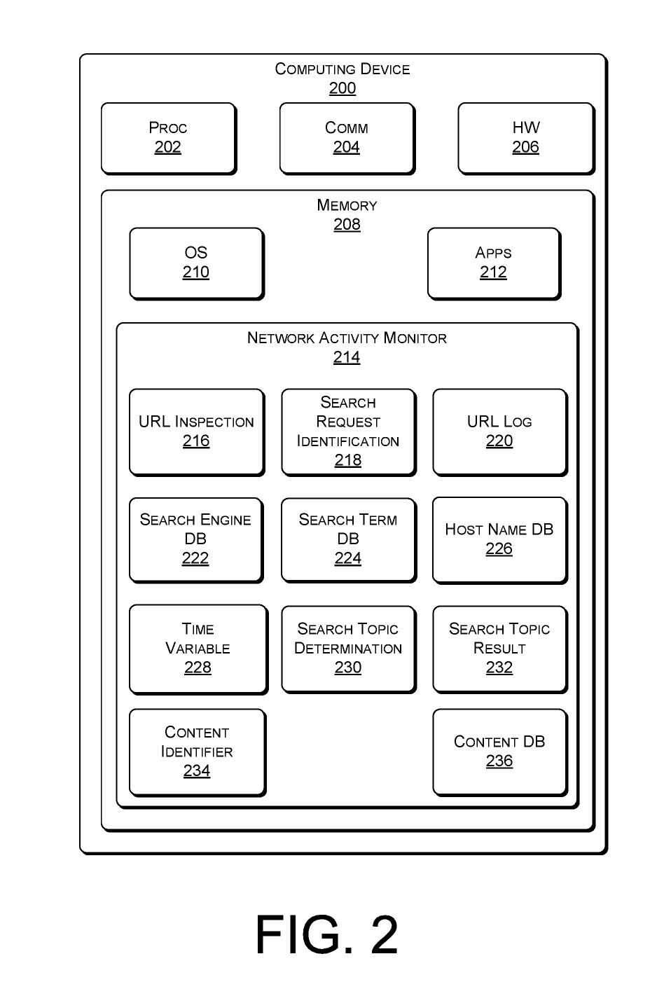

FIG. 2 is a diagram of an example computing device 200 in accordance with the technologies described herein. The one or more of the servers 118 shown in FIG. 1 are examples of the example computing device 200 in an operating environment, in particular, a network environment 100.

The example computing device 200 includes a processor 202 that includes electronic circuitry that executes instruction code segments by performing basic arithmetic, logical, control, memory, and input/output (I/O) operations specified by the instruction code. The processor 202 can be a product that is commercially available through companies such as Intel® or AMD®, or it can be one that is customized to work with and control and particular system.

The example computing device 200 also includes a communications interface 204 and miscellaneous hardware 206. The communication interface 204 facilitates communication with components located outside the example computing device 200, and provides networking capabilities for the example computing device 200. For example, the example computing device 200, by way of the communications interface 204, may exchange data with other electronic devices (e.g., laptops, computers, other servers, etc.) via one or more networks, such as the Internet 114 (FIG. 1) and web servers 118 (FIG. 1). Communications between the example computing device 200 and other electronic devices may utilize any sort of communication protocol known in the art for sending and receiving data and/or voice communications.

The miscellaneous hardware 206 includes hardware components and associated software and/or or firmware used to carry out device operations. Included in the miscellaneous hardware 206 are one or more user interface hardware components not shown individually—such as a keyboard, a mouse, a display, a microphone, a camera, and/or the like—that support user interaction with the example computing device 200.

The example computing device 200 also includes memory 208 that stores data, executable instructions, modules, components, data structures, etc. The memory 208 is be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions, for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 210 is stored in the memory 208 of the example computing device 200. The operating system 200 controls functionality of the processor 202, the communications interface 204, and the miscellaneous hardware 206. Furthermore, the operating system 210 includes components that enable the example computing device 200 to receive and transmit data via various inputs (e.g., user controls, network interfaces, and/or memory devices), as well as process data using the processor 202 to generate output. The operating system 210 can include a presentation component that controls presentation of output (e.g., display the data on an electronic display, store the data in memory, transmit the data to another electronic device, etc.). Additionally, the operating system 210 can include other components that perform various additional functions generally associated with a typical operating system. The memory 210 also stores various software applications 212, or programs, that provide or support functionality for the example computing device 200, or provide a general or specialized device user function that may or may not be related to the example computing device per se.

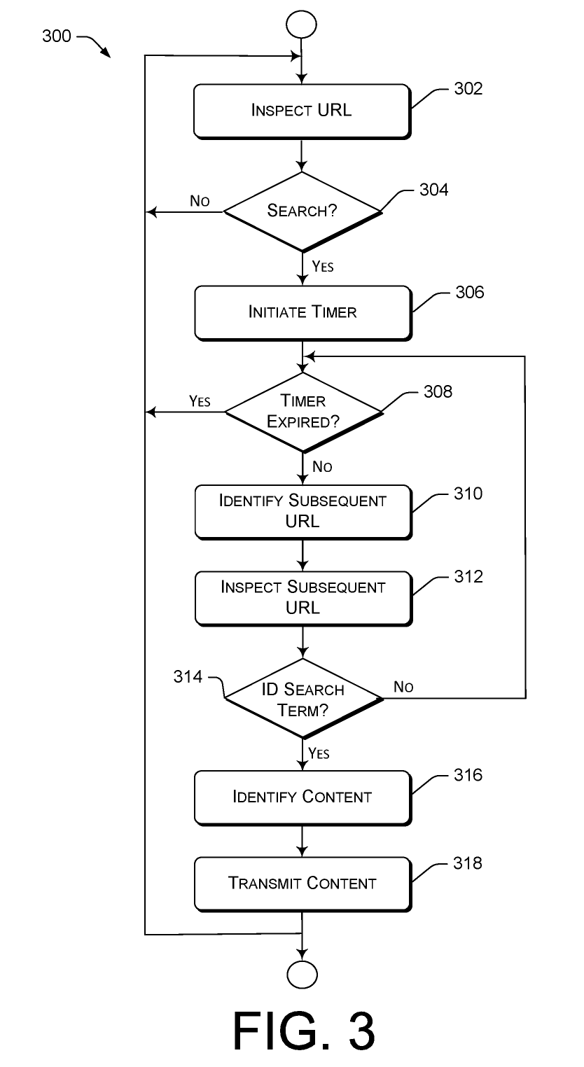

The memory 208 also stores a network activity monitor 214 that is similar to the network activity monitor 124 shown stored on the server(s) 118 in FIG. 1. The network activity monitor 214 performs and/or controls operations to carry out the techniques presented herein. The network activity monitor 124 includes several components that are described immediately below, and further below with respect to the functional flow diagram shown in FIG. 3.

In the following discussion, certain interactions may be attributed to particular components. It is noted that in at least one alternative implementation not particularly described herein, other component interactions and communications may be provided. The following discussion of FIG. 2 merely represents a subset of all possible implementations. Furthermore, although other implementations may differ, the network activity monitor 214 is described as a software application that includes, and has components that include, code segments of processor-executable instructions. As such, certain properties attributed to a particular component in the present description, may be performed by one or more other components in an alternate implementation. An alternate attribution of properties, or functions, within the network activity monitor 214, and even the example computing device 200 as a whole, is not intended to limit the scope of the techniques described herein or the claims appended hereto.

The network activity monitor 214 includes a URL (Uniform Resource Locator) inspection component 216 that is configured to locate, detect, and parse a URL entered by a user with the intention of navigating to a web site that is identified by the URL. In terms of the example cellular network environment 100 shown in FIG. 1, a URL is entered into a client device 108 and is transmitted to the core network 106 and forwarded, through the gateway 116 to the search engine server 126 or a web server 124 by way of the Internet 114. As the communication is made from the client device 108, the network activity monitor 214 (and 124 of FIG. 1) is able to inspect the contents of the URL because the core network 106 bears the responsibility of providing a connection to the requested URL.

The URL typically consists of a network IP address, such as “63.147.242.179.” The URL inspection component 216 is configured to identify a host DNS (Domain Name System) name from a network IP address. This can be accomplished by any method known in the art, such as by a reverse IP lookup or by using a Server Name Indication (SNI). Reverse IP Lookup is a way to discover all domain names hosted on any given IP address. SNI is an extension to the SSL (Secure Sockets Layer) and TLS (Transport Layer Security) protocols that indicates a server name or website that a client is attempting to connect with at the start of a handshake process. The URL inspection component 216 is also configured to provide a DNS name (derived from an IP address) to a search request identification component 218 of the network activity monitor 214. In at least one implementation, the URL inspection component 216 is further configured to log the DNS name in a URL log 220 of the network activity monitor 214.

The search request identification component 218 is configured at least to identify when a user of a client device 108 (FIG. 1) is performing a search request via the Internet 114 (FIG. 1). This may be accomplished in one or more of several ways. In at least one implementation, the search request identification component 218 determines if the URL includes a DNS name of a search engine site. This operation may be accomplished by comparing a URL DNS name to a search engine database 222 or other collection of known search engine sites. Basically, if a user navigates to a search engine site, it is likely that the user intends to perform a search.

The search engine database 222 includes a list of search engine websites. The content of the search engine database 222 varies from one implementation to another, based on what an implementer might think is a best practice. One option is to list at least a portion of the site name of a certain number of most-search engines, such as:
Google.com®
Bing.com®
Yahoo. com®
Baidu.com®
Ask. com®
AOLSearch.com®
DuckDuckGo.com®
WolframAlpha.com®
Yandex.com®
WebCrawler.com®
Search.com®
Dogpile.com®
ixquick.com®
excite. com®
info.com®

In at least one alternative implementation, a single search engine site, such as google.com®, may be hard-coded into the search request identification component 218.

Since options other than performing a search may be available at a search engine site, merely identifying a URL address as relating to a search engine provider web site is not typically enough to determine that a user has navigated to the web site in order to perform a search. However, a search request is an activity that produces a short URL, while other activities typically navigate using a longer URL. Therefore, the search request identification component 218 is further configured to discard URLs that are less than a threshold length as not being a URL associated with a search. The threshold length is an implementation detail that is determined in a specific implementation of a network activity monitor 214. For example, in at least one implementation, a threshold length of ten (10) second may be used.

Another method that may be implemented in the search request identification component 218 to identify when a search request is made, is to identify when a URL contains a DNS name of a website that is related to a known commercial entity, e.g., Macys® and the URL also contains a name of a commercial item. This technique may be used with URLs that are not encrypted, where search terms are visible. For this purpose, the network activity monitor 214 includes a search term database 224 and a host name database 226. The search term database 224 stores names of potential search terms that may be of interest to an implementer of the techniques described herein, such as “jackets,” “shoes,” “cell phone,” “bicycle,” etc. The host name database 226 stores names of commercial goods and/or services providers that can be compared with a DNS name found in a URL.

The host name database 226 stores a significant number of potential host names that relate to particular providers of goods and/or services, but that may refer to non-commercial hosts in one or more implementations. Efficiency considerations make it is likely that any particular implementation will have a limited number of entries in the host name database 226, and those entries will relate to particular providers of goods and/or services that are of interest to the implementer. In lieu of providing a host name database 226, a limited number of potential host names may be hard-coded into one or more other components of the network activity monitor 214.

It is noted that since many URLs contain encrypted information, it is not always possible to discern whether the URL includes a commercial item. In at least one implementation, several URLs navigated to by a user after a search request may be inspected. If at least one such URL contains unencrypted information, then looking for a commercial item may be possible. When several URLs appearing after a search request are to be monitored, it is feasible to consider a limit on the amount of time after the search request that a continuation of the search may be inferred. While it is likely that a web site visited by a user soon after the user performs a search request might be related to the search request, it becomes increasingly unlikely that a navigation is related to a search request as time passes between a time of the search request and a time that a subsequent navigation occurred. For this reason, the network activity monitor 214 includes a timer component 228 that determines an amount of time that URLs appearing after a search request are monitored because they are likely to relate to a topic of the search request. The timer component 228 may also provide a timing mechanism (i.e., a “timer”) that can be started, stopped, and reset. Once a search request has been identified, subsequent URLs of sites navigated to by a user will be inspected as being related to the search request for an amount of time indicated by the timer component 228. In one or more alternate implementation, such an amount of time may be configured to ten (10) seconds. In at least one other implementation, the timer component 228 may be replaced by a counter and a numerical value that indicates a number of URLs that are inspected after a search request has been made to determine a search request topic.

The network activity monitor 214 also includes a search topic determination component 230, which is configured to determine a topic of a user search. After a user navigation is determined to be a search request, the search topic determination component 230 uses one or more techniques to determine what, specifically, the user is searching for. There are multiple techniques available for making such a determination.

In at least one implementation, after the determination has been made that a URL indicates a search request, subsequent URL from the same user/device are examined. It is noted that a limited number of subsequent URLs are examined (limited by time or by number), since a site navigated to by a user relatively soon after performing a search is likely to be a site that was included in results from the search. As previously described, a reverse IP lookup or other technique may be used to identify a DNS name of a web site host listed in the host name database 226. The DNS name provides a hint to the subject matter of the search, such as if the DNS name is the name of a commercial provider that participates in a narrow market, then an assumption may be made that the search relates to that particular market. For example, if a network IP address is resolved to the DNS name “nike.com,”® then an assumption can be made that the user is searching for athletic-related goods, such as apparel.

In at least one alternative implementation, rather than looking for a name of a commercial provider in a URL, the search topic determination component 230 may look for a name of a specific item in a URL. For example, if an implementer is interested in identifying user's searching for information on toys, the search topic determination component 230 may identify URL “www.kites.com”® as being of interest. Comparison of terms found in a DNS name are made with terms stored in the search term database 224. URL “www.kites.com”® will be identified if the term “kite” or “kites” is included in the search term database 224.

In at least one alternate implementation, further processing is required, but may only be accomplished when a URL is not encrypted. In one such implementation, the URL inspection component 216 parses URLs that are open, i.e. unencrypted, to determine if a search topic can be identified, for instance, by comparing found URL terms to the search term database 224. For example, if a URL listing “http://www.funtoys.com/outdoortoys/kite” is encountered, and “kite” (or “kites”) is present in the search term database 224, then “kite” is be identified as a search term topic, and stored as a search topic result 232.

When a search topic result 232 is identified, a content identifier component 234 of the network activity monitor 214 is configured to access a content database 236 and find content related to the search topic result 232 that is to be transmitted, directly or indirectly, to the user that searched using the search topic result 232. Such content may be audio or video, tangible or electronic content. The content may be transmitted directly to the user, or it may be provided to an entity to either transmit the content to the user or to inform the entity's interactions with the user. Any use of content related to the user and to the search topic result 232 may be implemented in accordance with the present techniques.

Further functionality of the example computing device 200 and its component features is described in greater detail, below, with respect to an example of a methodological implementation of the novel techniques described and claimed herein.

### Example Methodological Implementation—Identifying User Intention

FIG. 3 is a flow diagram 300 that depicts a methodological implementation of at least one aspect of the techniques for identifying user intention from encrypted browsing activity disclosed herein. In the following discussion of FIG. 3, continuing reference is made to the elements and reference numerals shown in and described with respect to the example computing device 200 of FIG. 2. In the following discussion related to FIG. 3, certain operations may be ascribed to particular system elements shown in previous figures. However, alternative implementations may execute certain operations in conjunction with or wholly within a different element or component of the system(s).

At block 302, the URL inspection component 216 inspects a URL sent from a client device 108 (FIG. 1) over the cellular network 102 (FIG. 1). Although the example methodological implementation is shown relating to a cellular network, it is noted that a different type of network or system may be employed to provide client device connectivity with the Internet, and that the described techniques are not limited to use within a cellular network. A network IP address accessed by the URL inspection component 216 is converted—such as by reverse IP lookup or SNI—to identify a web site host DNS name associated with the network IP address. The URL and/or the web site host DNS name and/or the network IP address may be stored in the URL log 220.

At block 304, the search request identification component 218 attempts to identify if the received URL relates to a search request by a user of the client device 108 (FIG. 1). One way in which this is accomplished is by comparing the web site host DNS name with entries in the search engine database 222. If, for example, the web site host DNS name has a value of “duckduckgo.com®,” and “duckduckgo” or some variation thereof is included in the search engine database 222, then a determination is made that the URL constitutes a search request by the user. In at least one implementation not shown in FIG. 3, an additional filter is applied to the URL to make this determination only when the URL has fewer characters than a pre-specified value, based on an assumption that an activity other than a search request will include a greater number of characters than does a search request. For example, a URL consisting of thirty (30) characters or less may be discarded as being something other than a search request.

As previously discussed, another way in which the search request identification component 218 can determine if a URL is related to a search request is to determine that the web site host name is one belonging to a provider of interest (i.e., it matches a term in the host name database 226) and that the URL contains an item available from the provider (i.e., a matching term is included in the search term database 224). If the URL is encrypted, then only the host DNS name can be identified and this particular technique will be unavailable. But if the URL is comprehendible, then this technique may be used.

If a match is not found (“No” branch, block 304), then the process reverts to block 302 to inspect subsequent URLs. If it is determined that the URL relates to a search request (“Yes” branch, block 304), then the timer component 228 is initiated at block 306. When the timer expires (“Yes” branch, block 308), the process reverts to block 302 and subsequent URLs are monitored/inspected.

As long as the timer has not expired (“No” branch, block 308), a subsequent URL is identified at block 310. At block 312, the subsequent URL is inspected in an attempt to identify a search term from the URL. If the subsequent URL is encrypted, then the only item that can be determined is a host web site DNS name, such as “kitedepot.com.” If at least a portion of the host web site DNS name is included in the search term database 224 (e.g., “kite”), then a determination is made that the subject matter of the search is “kite,” which is stored as the search topic result 232.

If the subsequent URL is not encrypted, then the entire URL can be analyzed and compared to terms in the search term database 224. If a term in the search term database 224 is found in the subsequent URL, then that term is stored as the search topic result 232. For example, if the unencrypted URL is “http://www.hobbymecca.com/outdoors/summerfun/kites,” and a comparison with the search term database 224 identifies the term “kite,” then a determination is made that the user was searching for a kite, and the term “kite” is stored as the search topic result 232.

If a search term is not identified in the subsequent URL (“No” branch, block 314), then the process reverts to block 308 and if the timer has not expired, a next URL is analyzed. If a search term is identified in the subsequent URL (“Yes” branch, block 314), then the content identifier 234 compares the search topic result 232 with entries in the content database 236 (block 316) to locate content associated with the search topic result 232. In the previous example, the content identifier 234 searches for content related to “kite.” Such content may relate to articles about nearby locations popular for flying kites, or to information about kites available for sale in the local area, etc. If content is identified in the content database 236, then the content is transmitted at block 318.

The content may be transmitted directly to a user of the client device 108 (FIG. 1) used to perform the search utilizing the cellular network 102 (FIG. 1), such as by emailing or texting the content directly to the user device 108 (FIG. 1). In at least one alternate implementation, the content is transmitted to an entity other than the user, so that the entity may convey at least a portion of the content to the user, or may utilize information from the content in an interaction with the user, etc.

For example, if the user search topic 232 relates to cellular phones, a provider of the user's cellular phone may be interested to know that the user is looking at alternatives to the user's current arrangement with the cellular phone provider. In such a case, the cellular phone provider may receive content indicating that the user has been searching for alternative cellular phones or plans. The cellular phone provider, thus alerted to the user's frame of mind, may then wish to provide special incentives to the user to remain with the cellular phone provider plan.

In at least one alternative implementation, rather than pushing content to an interested entity, such as the cellular phone provider, an employee of the cellular phone provider may access the information when the user presents at a commercial location of the cellular phone provider. In this way, the interested entity can access the information at a time that is suitable for using the information.

After content has been identified and possible transmitted, the process reverts to block 302, where URLs continue to be monitored.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
identifying an encrypted client communication with a network as a search request;
identifying one or more sites contacted by the user after the search request;
determining a search topic from a URL associated with one of the one or more sites;
identify content for the user, said content related to the search topic; and
transmitting the content identified for the user to the user or to an entity associated with the user that can provide at least a portion of the content to the user.

2. The method as recited in claim 1, wherein the determining a search topic further comprises identifying a possible search term from a portion of a URL associated with a site.

3. The method as recited in claim 2, wherein identifying a possible search term further comprises identifying a term in the URL that is an item of commerce.

4. The method as recited in claim 1, wherein the determining a search topic further comprises identifying a search topic from a name of a site host indicated in a URL.

5. The method as recited in claim 1, wherein the identifying one or more sites contacted by the user after the search requests further comprises identifying one or more sites contacted by the user within a pre-determined time period after the search request has been identified.

6. The method as recited in claim 1, wherein the identifying an encrypted client communication with a network as a search request further comprises recognizing a URL to be a URL associated with a search engine.

7. The method as recited in claim 1, wherein the network further comprises a cellular network.

8. A system, comprising:
a plurality of client devices;
network infrastructure that provides connection of client devices to remote web sites via Internet;
a server having a processor and one or more electronic storage media that stores code instructions that are executable on the processor;
a network activity monitor component that includes code segments, including the following code segments:
a first code segment configured to identify an encrypted client communication with a remote web site as being a search request;
a second code segment configured to identify one or more sites contacted by the user after the search request;
a third code segment configured to determine a search topic from one or more URLs associated with the one or more sites;
a fourth code segment configured to identify content to transmit to the user, said content related to the search topic.

9. The system as recited in claim 8, wherein the first code segment is further configured to identify an encrypted client communication with a remote web site as being a search request by identifying a possible search term from a portion of a URL associated with the remote web site.

10. The system as recited in claim 9, wherein the identifying a possible search term further comprises identifying a term in the URL that is an item of commerce.

11. The system as recited in claim 8, wherein the third code segment being configured to determine a search topic further comprises the third code segment being configured to identify a search topic from a name of a site host indicated in a URL.

12. The system as recited in claim 8, wherein the second code segment being configured to identify one or more sites contacted by the user further comprises the second code segment being configured to identify one or more sites contacted by the user within a pre-determined time period after the search request has been identified.

13. The system as recited in claim 8, wherein the first code segment being configured to identify an encrypted client communication with a remote web site as being a search request further comprises the first code segment being configured to recognize a URL to be a URL that is associated with a search engine.

14. The system as recited in claim 8, wherein the network infrastructure further comprises a cellular network infrastructure.

15. One or more computer-readable storage media including computer-executable instructions that, when executed by a computer, perform the following operations:
monitoring web site URLs navigated to by a network client;
identifying when the client performs a search on a web site;
identifying one or more web site URLs navigated to by the client after the client performs a search;
determining a search topic from a URL associated with one or more of the web sites navigated to by the client;
communicating content, directly or indirectly, with the client, said content related to the search topic.

16. The one or more computer-readable storage media as recited in claim 15, wherein the identifying when the client performs a search on a web site further comprises identifying when a web site URL includes a possible search term.

17. The one or more computer-readable storage media as recited in claim 16, wherein identifying when a web site URL includes a possible search term further comprises identifying a name of an item of commerce included in a web site URL.

18. The one or more computer-readable storage media as recited in claim 15, wherein the determining a search topic from a URL further comprises determining a search topic based on the name of a site host indicated in the URL.

19. The one or more computer-readable storage media as recited in claim 15, wherein the identifying one or more web site URLs navigated to by the client after the client performs a search is performed for a certain time period after the client performs the search.

20. The one or more computer-readable storage media as recited in claim 15, wherein the identifying when the client performs a search on a web site further comprises recognizing a URL that is associated with a search engine web site.
